(19) United States
(12) Patent Application Publication
(10) Pub. No.: US 2014/0325183 A1
(43) Pub. Date: Oct. 30, 2014

(54) INTEGRATED CIRCUIT DEVICE, ASYMMETRIC MULTI-CORE PROCESSING MODULE, ELECTRONIC DEVICE AND METHOD OF MANAGING EXECUTION OF COMPUTER PROGRAM CODE THEREFOR

(71) Applicants: Anton Rozen, Gedera (IL); Dan Kuzmin, Givat Shmuel (IL); Michael Priel, Netanya (IL); Leonid Smolyansky, Zichron Yakov (IL)

(72) Inventors: Anton Rozen, Gedera (IL); Dan Kuzmin, Givat Shmuel (IL); Michael Priel, Netanya (IL); Leonid Smolyansky, Zichron Yakov (IL)

(73) Assignee: FREESCALE SEMICONDUCTOR, INC., Austin, TX (US)

(21) Appl. No.: 14/358,053

(22) PCT Filed: Nov. 28, 2011
(86) PCT No.: PCT/IB2011/055326

§ 371 Date: May 14, 2014

(51) Int. Cl. G06F 15/76

(52) U.S. Cl. CPC G06F 15/76; G06F 2015/765
USPC 712/30

(57) ABSTRACT

An asymmetric multi-core processing module is described. The asymmetric multi-core processing module comprises at least one processing core of a first type, at least one processing core of at least one further type, and at least one core identifier configuration component. The at least one core identifier configuration component is arranged to enable dynamic configuration of a value of a core identifier of at least one of the processing cores of the first and at least one further types.

### FIELD OF THE INVENTION

The field of this invention relates to an integrated circuit device, an asymmetric multi-core processing module, and electronic device and a method of managing execution of computer program code therefor.

### BACKGROUND OF THE INVENTION

Integrated circuit devices that are intended for use within, for example, mobile devices such as wireless communication devices are required to meet high performance requirements and strict power consumption constraints. In order to meet the high performance requirements, integrated circuit devices currently implement high-speed processing cores. Conversely, in order to meet the strict power consumption constraints, slower processing cores have to be used. In order to meet both opposites, i.e. the performance requirements and the power consumption constraints, such integrated circuit devices can implement asymmetric multi-core platforms comprising a mix of high performance cores and low power cores.

However, a problem with such asymmetric multi-core platforms is that they are not supported by conventional software.

### SUMMARY OF THE INVENTION

The present invention provides an integrated circuit device, an asymmetric multi-core processing module, an electronic device, a method of managing execution of computer program code and a non-transitory computer program product as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified block diagram of an example of a part of an electronic device.

FIG. 2 illustrates a simplified block diagram of an example of part of an integrated circuit device.

FIG. 3 illustrates a simplified block diagram of an example of a core identifier configuration component.

FIG. 4 illustrates a simplified flowchart of an example of a method of managing execution of computer program code.

### DETAILED DESCRIPTION

The present invention will now be described with reference to an integrated circuit device comprising at least one asymmetric multi-core processing module for use in a wireless communication unit, and a method of managing execution of computer program code therefor. However, it will be appreciated that the present invention is not limited solely to wireless communication applications, but may be equally applied to any integrated circuit device application that comprises one or more asymmetric multi-core platforms.

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

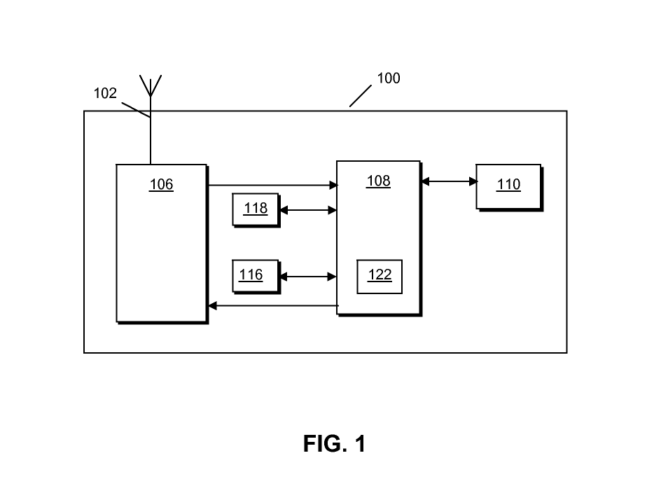

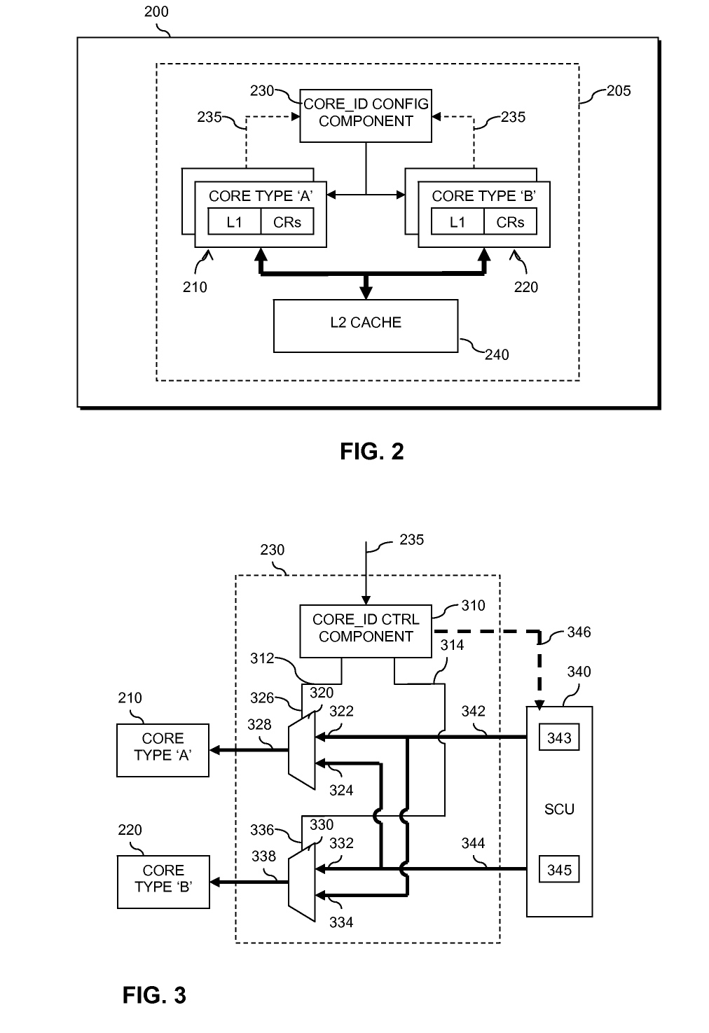

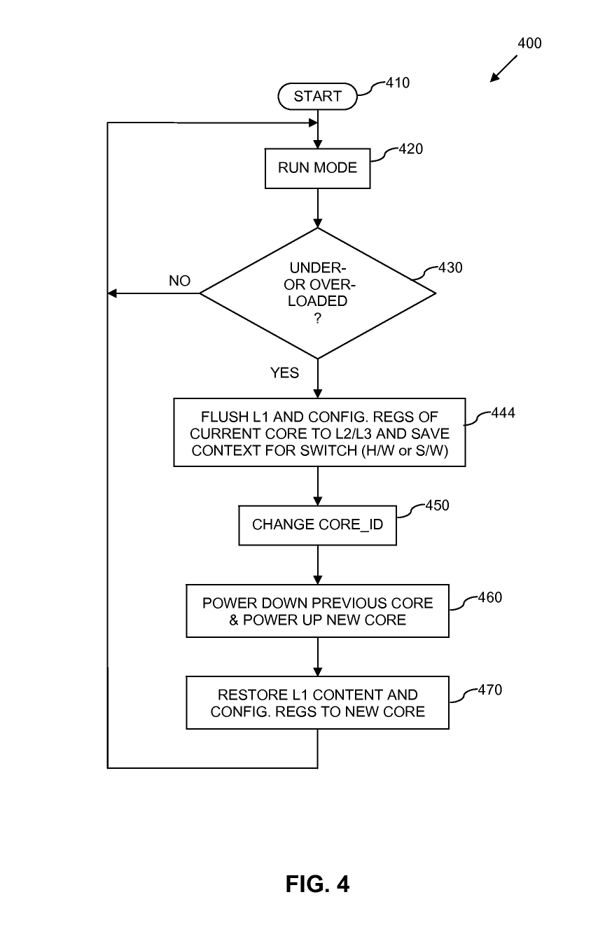

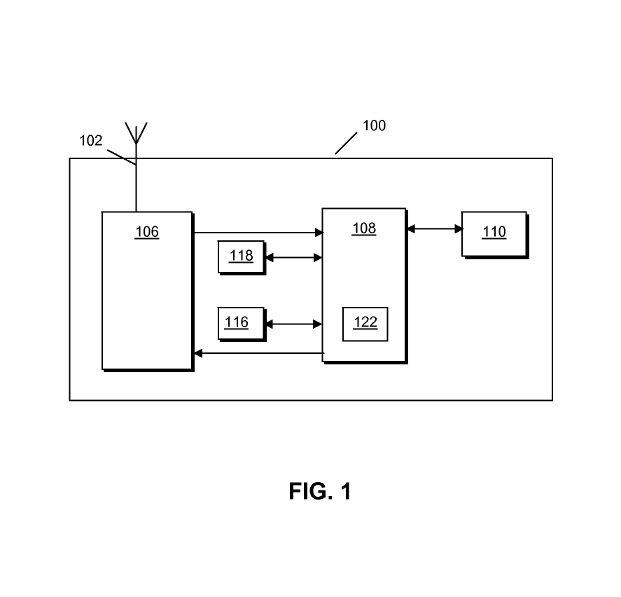

Referring first to FIG. 1, there is illustrated a simplified block diagram of an example of a part of an electronic device, which in this example is a wireless communication unit 100. The wireless communication unit 100, in the example, is a mobile telephone handset comprising an antenna 102. The wireless communication unit 100 contains a variety of well known radio frequency (RF) components or circuits 106, operably coupled to the antenna 102 that will not be described further herein. The wireless communication unit 100 further comprises signal processing logic 108. An output from the signal processing logic 108 is connected to a suitable user interface (UI) 110 comprising, for example, a display, keypad, microphone, speaker etc., to output signals in a human perceptible form to a user.

In the example, the signal processing logic 108 is coupled to a memory element 116 that stores operating regimes, such as decoding/encoding functions and the like and may be realised in a variety of technologies, such as: random access memory (RAM) (volatile), (non-volatile) read only memory (ROM), Flash memory or any combination of these or other memory technologies. A timer 118 may be coupled to the signal processing logic 108 to control the timing of operations within the wireless communication unit 100.

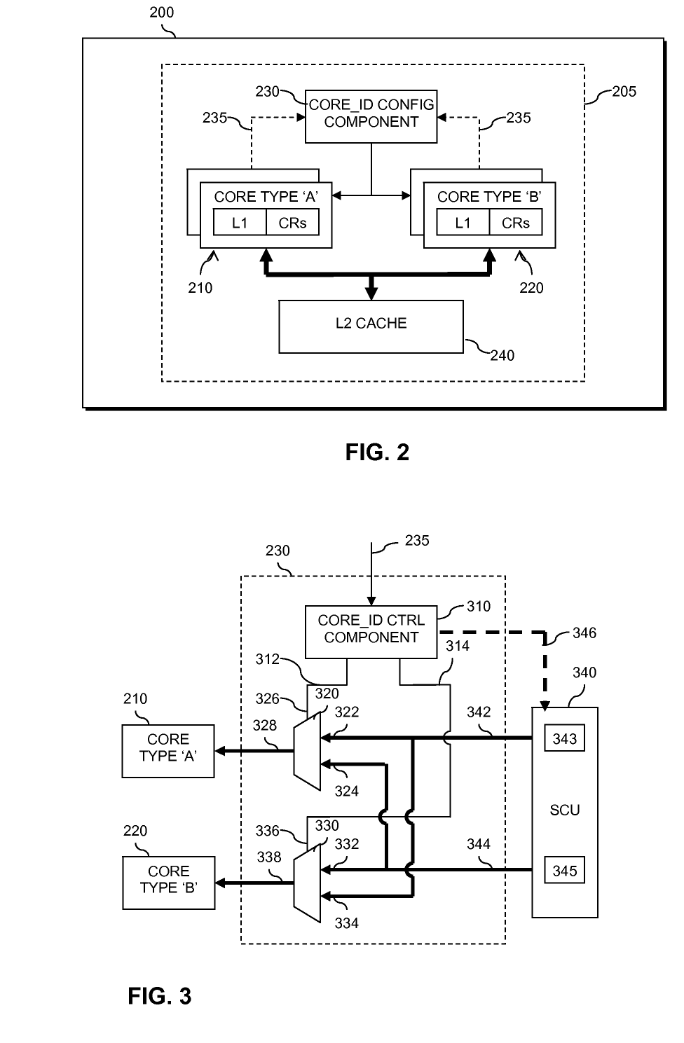

Referring to now to FIG. 2, there is illustrated a simplified block diagram of an example of part of an integrated circuit device 200, such as may be implemented within, say, the radio frequency components or circuits 106 and/or the signal processing logic 108 of the wireless communication unit 100 of FIG. 1. The integrated circuit device 200 of FIG. 2 comprises one or more asymmetric multi-core processing modules, such as the asymmetric multi-core processing module 205. The asymmetric multi-core processing module 205 comprises one or more processing cores of a first type, denoted as core type ‘A’ 210 in the illustrated example. The asymmetric multi-core processing module 205 further comprises one or more processing cores of at least one further type, such as the processing cores denoted as core type ‘B’ 220 in the illustrated example. For example, the one or more processing cores of type ‘A’ may comprise, say, higher performance processing cores, whilst the one or more processing cores of type ‘B’ may comprise, say, lower power processing cores with a lower power consumption than the higher performance processing cores and less performance.

The asymmetric multi-core processing module 205 still further comprises a core identifier configuration component 230 operably coupled to the processing cores 210, 220 and arranged to provide core identifier values to the processing cores 210, 220 coupled thereto. Such core identifier values may comprise, in some examples, integer values used to enable individual processing cores 210, 220 to be identified, such that software threads or tasks may be managed to execute on processing cores 210, 220 comprising specific core identifier values. The core identifier configuration component 230 is further arranged to enable dynamic configuration of a core identifier of at least one of the processing cores 210, 220. In this manner, the core identifier for such a processing core 210, 220 (e.g. a target core) may be configured such that, say, computer program code executing on another processing core 210, 220 (e.g. an initial core) of the asymmetric multi-core processing module 205 may be transparently switched to executing on the target core 210, 220; whereby the core identifier of the target core 210, 220 may be dynamically configured to comprise a core identifier value of the initial core 210, 220. In this manner, because the core identifier value of the processing core that is executing the computer program code remains constant, even after execution switches between processing cores 210, 220, the computer program code is not required to support switching of processor cores.

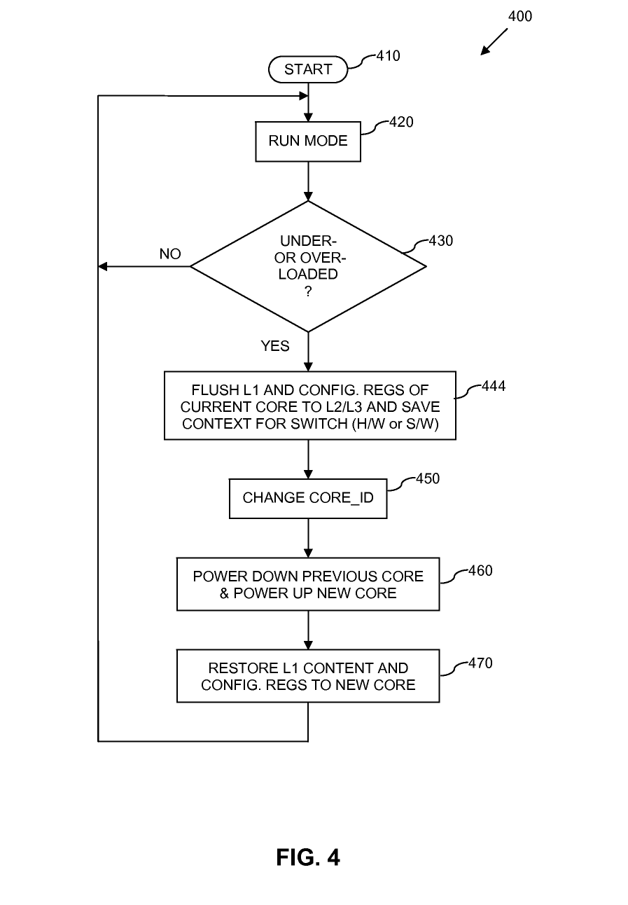

By way of example, a hypervisor program (not shown) or other core management software or hardware may be arranged to monitor a load of a processing core executing computer program code, as would be readily understood by a skilled artisan. A hypervisor program typically comprises a part of software that routes particular software threads or tasks to particular processing cores 210, 220 for execution. If the hypervisor program determines that the processing core is, say, overloaded or under-loaded, the hypervisor program may be arranged to initiate a switch of the execution of software code from a first (initial)) processing core of a first type to another processing core of a second type. As part of initiating such a switch, the hypervisor program may be arranged to request, for example via control signals 235, the core identifier configuration component 230 in order to dynamically configure the core identifier of the second (target) processing core to be set to the core identifier value of the first processing core, as described in greater detail with reference to FIG. 4 below.

In particular for the illustrated example, the core identifier configuration component 230 may be arranged to enable a core identifier for, say, a processing core of type ‘A’ 210 to be set to a core identifier value of a processing core of type ‘B’. In this manner, by configuring the core identifier for the processing core of type ‘A’ to have the value of a processing core of type ‘B’, computer program code executing on the processing core of type ‘B’ may be transparently switched to executing on the processing core of type ‘A’. Similarly, the core identifier configuration component 230 may be additionally arranged to enable a core identifier for a processing core of type ‘B’ 210 to be configured to a core identifier value of a processing core of type ‘A’, thereby enabling execution of program code to be transparently switched been processing core types in either direction.

For example, in a case where computer program code is being executed on a first processing core of type ‘A’ 210, which comprises a higher performance processing core, such a hypervisor program may determine that this first processing core 210 is under-loaded. As such, the hypervisor program may initiate a switch of the execution of the mentioned code to a second processing core of type ‘B’ 220, which comprises a lower power processing core. For example, where a software thread/task is configured to run on a higher performance processing core (e.g. core_#0), and where core_#1 is a lower power processing core:
if core_#0 load<threshold: switch core identifiers (core_#0, core_#1)

In the above example, the decision to change core identifiers is taken based on system load. However, such a decision may additionally/alternatively be made depending on, for example, system power consumption, temperature, etc. Initiating the switch of the execution of the code may include requesting the core identifier configuration component 230 to dynamically configure the core identifier of the second processing core 220 to be set to the core identifier value of the first processing core 210 prior to, or substantially simultaneously as, switching execution of the computer program code from the first processing core 210 to the second processing core 220. In this manner, since the first, higher performance, processing core 210 was under-loaded when executing the computer program code, execution of the computer program code may be transparently switched to the second, lower power, processing core 210 without significantly impacting on the performance with regard to execution of that computer program code, whilst enabling power consumption to be reduced.

Conversely, in a case where computer program code is being executed on a first, lower power, processing core of type ‘B’ 220, a hypervisor program may determine that the first processing core 220 is overloaded. As such, the hypervisor program may initiate a switch to a second, higher performance, processing core of type ‘A’ 210, including requesting the core identifier configuration component 230 to dynamically configure the core identifier of the second processing core 210 to be set to a core identifier value of the first processing core 220 prior to, or substantially simultaneously as, switching execution of the computer program code from the first processing core 220 to the second processing core 210. In this manner, since the first, lower power, processing core 220 was overloaded when executing the computer program code, execution of the computer program code may be transparently switched to the second, higher power processing core 220, for example in order to improve performance with regard to execution of that computer program code.

In the above examples, only a single identifier is configured. However, it will be apparent that multiple identifiers may be configured simultaneously, either dependent or independent from each other. For example, when the core identifier configuration component 230 configures the core identifier of a target processing core to comprise a core identifier value of an initial processing core, the core identifier configuration component 230 may be also arranged to simultaneously configure the core identifier of the target processing core to comprise a core identifier value of the target processing core. In this manner, the core identifier configuration component 230 may be arranged to enable core identifier values for the initial and target processing cores to be swapped. Accordingly, code execution in the initial processing core can be transferred to the target core and vice versa in a transparent manner in a single configuration.

Referring now to FIG. 3, there is illustrated a simplified block diagram of an example of an implementation of the core identifier configuration component 230. In the illustrated example, the core identifier configuration component 230 comprises a core identifier control component 310. The core identifier configuration component 230 further comprises a first core identifier selector component 320, which in the illustrated example comprises a multiplexer. The first core identifier selector component 320 comprises a first core identifier input 322 arranged to receive a first core identifier value 342, a second core identifier input 324 arranged to receive a second core identifier value 344, a control input 326 arranged to receive a selector signal 312, and an output 328 operably coupled to one of the processing cores, which in the illustrated example comprises a processing core of type ‘A’ 210. The core identifier selector component 320 is arranged to output one of the received core identifier values 342, 344 in accordance with the received selector signal 312 to the processing core 210 in order to set the core identifier therefor. For example, the core identifier selector component 320 may be arranged to output, say, the first core identifier value 342 received at the first core identifier input 322 upon the selector signal 312 comprising a ‘0’ value, and to output the second core identifier value 344 received at the second core identifier input 324 upon the selector signal 3122 comprising a ‘1’ value. In the illustrated example, the core identifier values 342 are received from a Snooping Control Unit (SCU) 340 which may also be arranged to perform, for example, inter-core cache memory synchronization, and other CPU platform tasks.

Additionally, for the illustrated example, the core identifier configuration component 230 further comprises a second core identifier selection component 330, which again in the illustrated example comprises a multiplexer. The second core identifier selector component 330 comprises a first core identifier input 332 arranged to receive the second core identifier value 344, a second core identifier input 334 arranged to receive the first core identifier value 342, a control input 336 arranged to receive a selector signal 314, and an output 338 operably coupled to one of the processing cores, which in the illustrated example comprises a processing core of type ‘B’ 220. The core identifier selector component 330 is arranged to output one of the received core identifier values 342, 344 in accordance with the received selector signal 314.

In the illustrated example, the core identifier configuration component 230 is illustrated as comprising two core identifier selector components 320, 330; one arranged to output a core identifier value to a first processing core of type ‘A’ 210 and one arranged to output a core identifier value to a second processing core of type ‘B’ 220. In this manner, processing cores 210, 220 and their respective core identifier selector components 320, 330 may be ‘paired’ to enable direct swapping of identifier values 342, 344 there between. In addition, the core identifier configuration component 230 may comprise multiple pairs of core identifier selector components 320, 330 arranged to provide core identifier values to corresponding pairs of processing cores 210, 220.

Alternatively, each core identifier selector component 320, 330 may be arranged to configure a core identifier of its respective core independently; accordingly each core identifier selector component 320, 330 may be arranged to receive any suitable number of core identifier values, for example one for each core within the asymmetric multi-core processing module 205, or a subset thereof, and to output one of the received core identifier values to the respective processing core 210, 220.

In the example illustrated in FIG. 3, the core identifier control component 310 is arranged to configure, via the selector signals 312, 314, the core identifier selector components 320, 330 to provide required core identifier values 342, 344 to their respective processing cores 210, 220, in response to control signals 235 from, for example, one or more hypervisor programs. Specifically for the illustrated example, the core identifier control component 310 is arranged to provide independent selector signals 312, 314 to each of the core identifier selector components 320, 330. However, in some examples, a single common selection signal may be provided to more than one core identifier selector component 320, 330. For example, where two core identifier selector components 320, 330 are paired to enable direct swapping between respective processing cores, a single selection signal may be provided to the pair of core identifier selector components.

In some examples, the core identifier control component 310 may be alternatively arranged to configure the core identifier values 342, 344 output by, in the illustrated example, the SCU 340. For example, the SCU 340 may be arranged to output, as the core identifier values 342, 344, values stored within programmable registers 343, 345 respectively. Accordingly, the core identifier control component 310 may be arranged to set new core identifier values 342, 344 for one or more processing cores 210, 220 by directly writing the new values to the appropriate programmable register 343, 345 within the SCU 340, for example via a register write signal illustrated generally at 346. In this manner, the core identifier values 342, 344 output by the SCU 340 may be provided directly to the respective processing cores 210, 220, substantially alleviating the need for the multiplexers 320, 330.

Referring back to FIG. 2, when execution of computer program code is switched from one processing core to another, the content of, for example an L1 cache and/or configuration registers of the initial processing core, should also be transferred to the target processing core along with the core identifier value; thereby enabling a complete transfer of the program context from the initial processing core to the target processing core. Any suitable manner of transferring such content between processing cores may be implemented, for example such as flushing the content of the initial processing core to L2/L3 cache, for example in a similar manner as for dormant mode save and restore procedures implemented within ARM™ processors.

Alternatively, a method of transferring a context such as disclosed in United States patent application number US 2011/022869 A1 may be implemented to transfer content between the processing cores. Content of the processing cores may be alternatively transferred by way direct registers, by bus, scan chains, or retention flip-flop data transfer, etc.

In the illustrated example, the asymmetric multi-core processing module 205 comprises a shared L2 cache memory element 240 of which the content is accessible by both the processing cores of type ‘A’ 210 and by processing cores of type ‘B’ 220. In this manner, L2 content may be preserved during a context transfer from one processing core of the asymmetric multi-core processing module to another processing core thereof. In particular, L2 content corresponding to computer program code being switched from executing on one processing core to another processing core may be preserved, and will be readily accessible from the new processing core. In this manner, the latency of switching execution of computer program code from one processing core to another may be significantly reduced in comparison to, say, solutions in which separate L2 cache memory elements are implemented for the different types of processing cores. In this manner, fast, dynamic switching of computer program code execution between different processing cores may be achieved.

Thus, for some examples of the present invention, the asymmetric multi-core processing module 205 illustrated in FIG. 1, and in particular an ability to dynamically configure core identifiers for processing cores thereof, enables the execution of computer program code to be dynamically switched from one processing core to another. For example, in a case of a four-core processing module comprising, say, two higher performance processing cores and two lower power processing cores, the four-core processing module may be arranged to function as a dynamically configurable two-core processing module wherein only one from each of a higher performance/lower power pair of processing cores executes computer program code at any given time. Alternatively, such a four-core processing module may be arranged to function as a dynamically configurable four-core processing module, wherein all four processing cores are available for executing computer program code, and thus where the various different types of processing core are configurable to operate simultaneously. In some examples, the four processing cores may be ‘prioritized’ based on their performance/power consumption characteristics, and a pre-defined and/or dynamically configurable power/performance scheme. For example, for a power/performance scheme in which performance is prioritized over low power consumption, the higher performance processing cores may be prioritized over the lower power processing cores. Conversely, for a power/performance scheme in which low power consumption is prioritized over performance, the lower power processing cores may be prioritized over the higher performance processing cores.

Referring now to FIG. 4, there is illustrated a simplified flowchart 400 of an example of a method of managing execution of computer program code, for example as may be implemented within a hypervisor program executing within the asymmetric multi-core processing module 205 of FIG. 2. In summary, the method comprises determining that execution of the computer program code is to be switched from a first processing core to a second processing core, configuring a core identifier for the second processing core to comprise a core identifier value of the first processing core, and switching execution of the computer program code from the first processing core to the second processing core. For example, the method may comprise swapping processing core identifier values for the first and second processing cores, wherein the first processing core comprises a first type of processing core and the second processing core comprises a second type of processing core. For example, the first and second processing cores may comprise a higher performance processing core and a lower power processing core.

More specifically, in the example illustrated in FIG. 4, the method starts at 410, and moves on to 420 where computer program code is executed during run time on a processing core. Next, at 430, it is determined whether (or not) the processing core that is executing the computer program code is under- or over-loaded, as appropriate. For example, where the processing core comprises a higher performance processing core, it may be determined that the processing core is under-loaded based on, say, system power consumption, system load, temperature, etc. Conversely, if the processing core is a lower power processing core, it may be determined that the processing core is overloaded based on, say, system power consumption, system load, temperature, etc. If it is determined that the processing core is not over-/under-loaded, the method loops back to 420 and the computer program code continues being executed in run-time. However, if it is determined that the processing core is over-/under-loaded (as appropriate), the method moves on to 440 where a content of the current processing core, such as the content of the L1 cache and configuration registers, is flushed to shared L2/L3 cache memory in order for it to be transferred to a target processing core (e.g. cache memory accessible by both the current processing core and the target processing core), and a context of the current processing core is saved. The core identifier value of the current processing core, in this example, is configured as the core identifier for a new, target processing core, at 450. Next, at 460, optionally, the current processing core may be powered down, and the new, target processing core may be powered up. The previously flushed content is then restored to the new, target processing core, and the saved context is transferred to the new, target processing core in order to enable transparent switching of the execution of the computer program code to the new target processing core at 470. The method then loops back to 420 with the computer program code being executed during run-time on the new processing core.

For the illustrated examples hereinbefore described, processing cores have been described as comprising either higher performance processing cores or lower power processing cores in order to aid understanding of the present invention. However, it will be appreciated that the present invention is not limited to applications comprising just these two types of processing cores, and the present invention may be implemented within any asymmetric multi-core platforms comprising substantially any configuration of processing core types. For example, the present invention is not limited to being implemented within a multi-core platform comprising substantially equal numbers of higher performance and lower power processing cores, such as a quad-core module comprising two higher performance processing cores and two lower power processing cores. Furthermore, for example, the present invention may be implemented within a multi-core platform comprising different numbers of higher performance and lower power processing cores, such as a quad-core module comprising one higher performance processing core and three lower power processing cores, or a quad-core module comprising one higher performance processing core, two ‘regular’ processing cores, and one lower power processing core.

At least parts of the invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims, and that accordingly these are not limited to the examples described.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms ‘assert’ or ‘set’ and ‘negate’ (or ‘de-assert’ or ‘clear’) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An asymmetric multi-core processing module; the asymmetric multi-core processing module comprising:
at least one processing core of a first type;
at least one processing core of at least one further type; and
at least one core identifier configuration component;
wherein the at least one core identifier configuration component is arranged to enable dynamic configuration of a value of a core identifier of at least one of the processing cores of the first and at least one further type(s).

2. The asymmetric multi-core processing module of claim 1, wherein the at least one core identifier configuration component is arranged to set a core identifier for the at least one processing core of the first type to be configured to a core identifier value of the at least one processing core of the at least one further type.

3. The asymmetric multi-core processing module of claim 2, wherein the at least one core identifier configuration component is arranged to swap core identifier values for the at least one processing core of the first type and the at least one processing core of the at least one further type(s).

4. The asymmetric multi-core processing module of claim 1, wherein the at least one core identifier configuration component comprises at least one core identifier selector component comprising:
a first core identifier input arranged to receive at least a first core identifier value;
at least one further core identifier input arranged to receive at least one further core identifier value;
at least one control input arranged to receive at least one selector signal; and
at least one output operably coupled to at least one of the processing cores of the first and at least one further type(s), and arranged to output to said processing core(s) at least one of the received first and at least one further core identifier values thereto in accordance with the at least one selector signal.

5. The asymmetric multi-core processing module of claim 4 wherein the at least one core identifier selector component comprises at least one multiplexer comprising:
a first core identifier input arranged to receive at least the first core identifier value;
at least one further core identifier input arranged to receive the at least one further core identifier value;
at least one control input arranged to receive the at least one selector signal; and
at least one output operably coupled to the at least one of the processing cores of the first and at least one further types, and arranged to output to said processing core(s) at least one of the received first and at least one further core identifier values thereto in accordance with the at least one selector signal.

6. The asymmetric multi-core processing module of claim 1, wherein the at least one asymmetric multi-core processing module comprises at least one shared L2 cache memory element accessible by the at least one processing core of the first type and the at least one processing core of at least one further type.

7. The asymmetric multi-core processing module of claim 1, wherein the at least one processing core of the first type and the at least one processing core of the second type are configurable to operate simultaneously.

8. The asymmetric multi-core processing module of claim 1, wherein the asymmetric multi-core processing module comprises at least one higher performance processing core and at least one lower power processing core.

9. The asymmetric multi-core processing module of claim 1, implemented as an integrated circuit device comprising at least one die in a single package.

10. An electronic device comprising the asymmetric multi-core processing module of claim 1.

11. A method of managing execution of computer program code, the method comprising:
determining that execution of the computer program code is to be switched from a first processing core to a second processing core;
dynamically configuring a value of a core identifier for the second processing core to be set to a core identifier value of the first processing core; and
switching execution of the computer program code from the first processing core to the second processing core.

12. The method of claim 11 wherein the method comprises swapping processing core identifier values for the first and second processing cores.

13. The method of claim 11 wherein the first processing core comprises a first type of processing core and the second processing core comprises a second type of processing core.

14. The method of claim 13 wherein the first and second processing cores comprise a higher performance processing core and a lower power processing core.

15. The method of claim 11 wherein the method further comprises determining that execution of the computer program code is to be switched if the first processing core is determined to be at least one of overloaded and under-loaded.

16. The method of claim 11 wherein the method further comprises flushing at least one of L1 cache content and configuration register content of the first processing core to a shared L2 cache memory element, prior to switching execution of the computer program code from the first processing core to the second processing core.

17. A non-transitory computer program product having executable program code stored therein for programming signal processing logic to perform a method of managing execution of computer program code, the code operable for:
determining that execution of the computer program code is to be switched from a first processing core to a second processing core;
dynamically configuring a value of a core identifier for the second processing core to be set to a core identifier value of the first processing core; and
switching execution of the computer program code from the first processing core to the second processing core.

18. The non-transitory computer program product of claim 17 wherein the computer readable storage medium comprises at least one of: a hard disk, a CD-ROM, an optical storage device, a magnetic storage device, a Read Only Memory, ROM, a Programmable Read Only Memory, PROM, an Erasable Programmable Read Only Memory, EPROM, an Electrically Erasable Programmable Read Only Memory, EEPROM, and a Flash memory.
